(19) United States
(12) Patent Application Publication
(10) Pub. No.: US 2019/0178664 A1
(43) Pub. Date: Jun. 13, 2019

(54) METHODS AND APPARATUS FOR ON-DEMAND FUEL DELIVERY

(71) Applicant: Ford Global Technologies, LLC, Dearborn, MI (US)

(72) Inventors: Aed M. DUDAR, Dearborn, MI (US); Kevin LUCKA, Dearborn, MI (US); Dennis Seung-Man YANG, Dearborn, MI (US); Mohammad R. AGHILI, Dearborn, MI (US); Finn Finn TSENG, Dearborn, MI (US)

(21) Appl. No.: 16/301,530

(22) PCT Filed: May 16, 2016
(86) PCT No.: PCT/US16/32656

§ 371 Date: Nov. 14, 2018

(51) Int. Cl. G01C 21/34; G01C 21/36; G06Q 10/06

(52) U.S. Cl. CPC G01C 21/3469; G06Q 10/06311; G01C 21/3697; G01C 21/3617

(57) ABSTRACT

Methods and apparatus for on-demand fuel delivery are disclosed herein. An example method includes predicting, by executing an instruction with a processor, a vehicle usage event for a vehicle. The predicted vehicle usage event is associated with a fuel amount. The example method includes comparing a fuel level of the vehicle and the fuel amount. The example method includes automatically generating, via the processor, a refuel request for the vehicle based on the comparison and transmitting the refuel request to a mobile device. The refuel request is to be viewable via a user interface at the mobile device.

### FIELD OF THE DISCLOSURE

This disclosure relates generally to automotive fueling, and, more particularly, to methods and apparatus for on-demand fuel delivery.

### BACKGROUND

Refueling a vehicle typically involves a driver recognizing that the vehicle does not have sufficient fuel to reach a destination and driving to a gas station to obtain the fuel for the vehicle. Refueling a vehicle at a gas station can be an inconvenience for the driver.

### SUMMARY

An example method disclosed herein includes predicting, by executing an instruction with a processor, a vehicle usage event for a vehicle. The predicted vehicle usage event is associated with a fuel amount. The example method includes comparing a fuel level of the vehicle and the fuel amount. The example method includes automatically generating, via the processor, a refuel request for the vehicle based on the comparison and transmitting the refuel request to a mobile device. The refuel request is to be viewable via a user interface at the mobile device.

An example system disclosed herein includes an analyzer to identify a driving pattern associated with a vehicle. The example system includes a predictor to predict a driving event for the vehicle based on the driving pattern. The predictor is to determine a fuel consumption of the vehicle for the predicted driving event. The example predictor is to perform a comparison of the fuel consumption to a fuel level of the vehicle. The example system includes a requestor to generate a refuel request based on the comparison and transmit the refuel request to a mobile device. At least one of the analyzer, the predictor, or the requester are to be implemented via a processor.

Another example method disclosed herein includes scheduling, by executing an instruction with a processor of a vehicle, a first refuel event for the vehicle. The example method includes transmitting, by executing an instruction with the processor, the scheduled refuel event to a mobile device. The scheduled refuel event is to be viewable via a user interface at the mobile device. The example method includes accessing, at the processor, data indicative of a completion of the first refuel event. The example method includes scheduling, by executing an instruction with the processor, a second refuel event based on the completion of the first refuel event.

### BRIEF DESCRIPTION OF THE DRAWINGS

FIG. 1 illustrates an example system including an example vehicle, an example mobile device for interacting with a control system of the example vehicle, and an example fuel provider for providing fuel to the vehicle in accordance with the teachings disclosed herein.

FIG. 2 is a block diagram of an example control system for use with the example vehicle of FIG. 1.

FIG. 3 is a block diagram of an example prediction system of the example control system of FIG. 2.

FIGS. 4 and 5 are flow diagrams of a first example method that may be executed to implement the example system of FIG. 1, and, in particular, the example control system of FIGS. 2 and 3.

FIG. 6 is a flow diagram of a second example method that may be executed to implement the example system of FIG. 1.

FIG. 7 is a diagram of an example processor platform that may be used to carry out the example methods of FIGS. 4-6 and/or, more generally, to implement the example system of FIG. 1.

The figures are not to scale. Wherever possible, the same reference numbers will be used throughout the drawing(s) and accompanying written description to refer to the same or like parts.

### DETAILED DESCRIPTION

Refueling a vehicle to provide the vehicle with enough fuel to reach a destination generally requires the driver of the vehicle to pay attention to fuel level, to locate gas stations along the driver's route, and to stop at one or more gas stations en route to the driver's destination. Monitoring the fuel level, planning refueling stops, and stopping to refuel the vehicle can be inconvenient for the driver. Although some known fueling services provide on-demand delivery of fuel to the vehicle without requiring the driver to visit a gas station, such services require the driver to request the fuel delivery to the vehicle. Thus, if the driver forgets or does not monitor the vehicle's fuel level, the vehicle may have insufficient fuel to reach a destination.

Example systems and methods disclosed herein automatically generate requests for fuel delivery from a fuel provider without requiring the driver to monitor the vehicle fuel level or to initiate the request for fuel delivery. The examples disclosed herein monitor the fuel level and detect when the fuel level is below a predetermined threshold. If the fuel level is below the predetermined threshold, the disclosed examples automatically generate a refuel request and send the request to the driver via an application installed on the driver's wireless-enabled mobile device (e.g., smartphone, tablet). The refuel request can include proposed times for scheduling refueling of the vehicle and/or serve as a reminder to the driver that the vehicle will need fuel. The driver can review the request and confirm that the refueling request should be sent to a provider in the driver's vicinity that provides on-demand fueling services. Upon acceptance of the request by the driver, the request is sent to a provider to complete delivery of fuel to the vehicle.

The examples disclosed herein also predict vehicle usage and, thus, refueling needs, based on an analysis of historical vehicle usage data, including, for example, the driver's driving patterns on weekdays and weekends with respect to routes, destinations, and stop durations. In view of the predictive analysis, the disclosed examples automatically schedule one or more refueling events to be performed by on-demand fuel providers in the driver's vicinity or along a predicted route, which can be confirmed by the driver via an application on the driver's mobile device. Thus, the disclosed examples consider both past vehicle usage and anticipated vehicle usage in generating requests for refueling events.

The disclosed examples also optimize the predictive scheduling of refueling events by considering factors that affect fuel prices, such as upcoming holidays, the geographical location of the vehicle, the day of the week, and/or the time of day. The disclosed examples leverage price drops in fuel by scheduling refueling events a few days before a holiday rather than over the holiday or in a geographical area that has a lower price gas than another geographical area along the driver's route. The disclosed examples also consider environmental restrictions on refueling that may be set by government agencies. For example, some states may restrict refueling events during the day. The disclosed examples account for such restrictions during scheduling of the refueling events.

When a driver or other user confirms a refuel request via the mobile device application, the disclosed examples automatically contact an on-demand fuel provider to schedule the refueling event. After the provider has provided the refueling service, the disclosed examples continue to dynamically monitor the fuel level and adjust predictively scheduled refueling events.

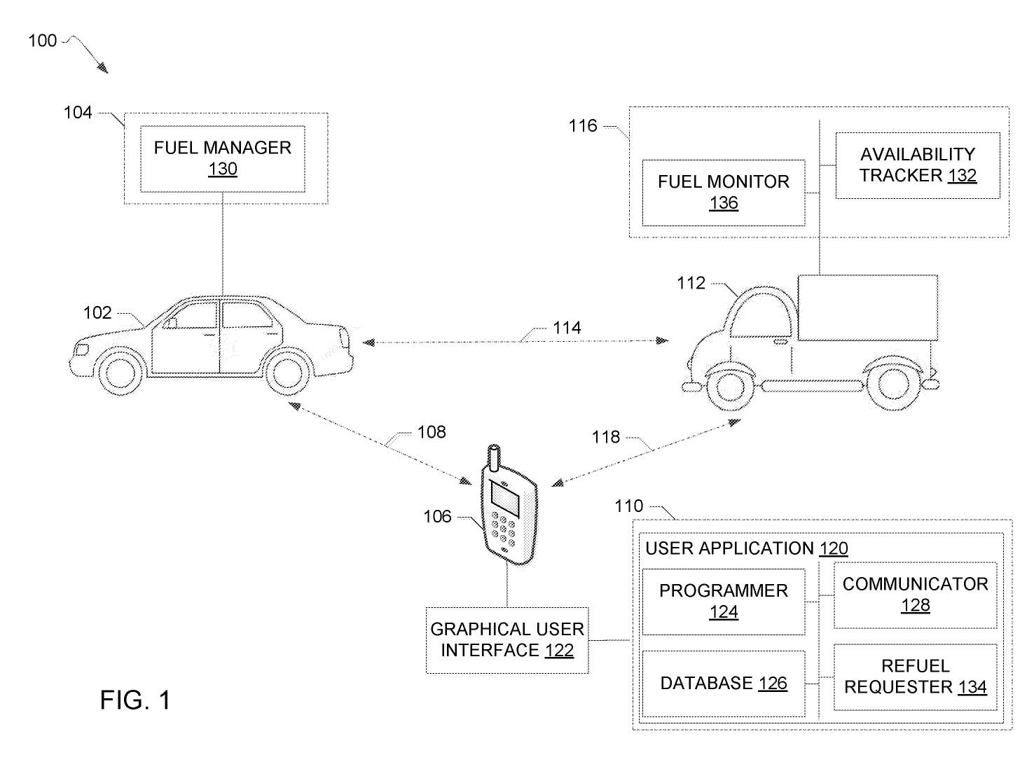

An example system 100 for on-demand fuel delivery to a vehicle 102 is illustrated in FIG. 1. The vehicle 102 can be any vehicle (e.g., an automobile) requiring gasoline or other fuel. The example vehicle 102 includes a first processor 104. The first processor 104 of the vehicle 102 controls and/or provides, for example, infotainment services such as music and navigation to a destination via Global Positioning Satellite (GPS) information. In the example system 100 of FIG. 1, the first processor 104 of the vehicle 102 is in wireless communication with a mobile device 106, as represented by a first arrow 108 in FIG. 1. The mobile device 106 can belong to, for example, a driver of the vehicle 102. The mobile device 106 of the example system 100 can be a smartphone, a tablet, or other device having wireless communication capability and including a second processor 110.

In the example system 100, the vehicle 102 also communicates wirelessly with a fuel provider 112, as represented by a second arrow 114 of FIG. 1. The fuel provider 112 can be, for example, associated with a gasoline service station that provides on-demand fuel delivery, or brings fuel to the vehicle 102 instead of the driver of the vehicle 102 driving to the gas station. To communicate with the vehicle 102, the fuel provider 112 is associated with a third processor 116. The third processor 116 can be in a vehicle of the fuel provider 112 used to deliver the fuel. In other examples, the third processor 116 is associated with a computing device or a mobile device operated by, for example, an employee of the fuel provider 112. In the example system 100, the fuel provider 112 communicates (e.g., wirelessly) with the mobile device 106 of the driver of the vehicle 102 or other user via the second processor 110 of the mobile device 106 and the third processor 116 of the fuel provider 112 to provide on-demand fuel delivery to the vehicle 102, as represented by a third arrow 118 of FIG. 1.

During operation of the vehicle 102, the vehicle 102 may run low on fuel such that additional fuel is needed for the vehicle 102 to reach an intended destination. Instead of driving to a gas station to refuel the vehicle 102, the driver of the vehicle 102 may prefer that fuel be delivered to the vehicle 102 so as not to require, for example, the driver to deviate from his route to visit a gas station. The driver of the vehicle 102 may prefer to be automatically alerted as to when fuel is needed or expected to be needed rather than having to visually monitor the fuel level of the vehicle 102. Also, the driver of the vehicle 102 may prefer fuel to be delivered to the vehicle 102 at a time that is convenient for the driver and/or based on other factors, such as variations in fuel costs between two or more geographical locations.

In the example system 100, the wireless communication between the mobile device 106 and the first processor 104 of the vehicle 102 provides for management of on-demand refuel requests for the vehicle 102. The second processor 110 of the mobile device 106 includes a user application 120, which may have been installed by the user of the mobile device 106. The user of the mobile device 106 interacts with the user application 120 via a graphical user interface (GUI) 122. The user application 120 enables the user to receive information from and send information to the first processor 104 of the vehicle 104.

The user application 120 includes a programmer 124. The programmer 124 allows the user of the mobile device 106 to input, via the GUI 122, a fuel level trigger or threshold, or a fuel amount that, when the fuel level of the vehicle 102 is below the threshold, indicates that the user wishes to have the vehicle 102 refueled. In some examples, the user can input two or more fuel level triggers. For example, the user can input a low fuel level trigger, or a fuel threshold amount that indicates that the user wants refueling to occur as soon as possible when the fuel level is below the low fuel level trigger and without consideration for factors such as fuel cost. The user can also input a high fuel level trigger, or a fuel threshold amount that allows for a predictive refueling analysis to be performed by the first processor 104 of the vehicle 102, as will be further disclosed below. The user can also input a fuel price trigger or threshold, or a fuel price that, when the price of fuel is below the threshold, indicates that the user wishes to have the vehicle 102 refueled, even if the vehicle 102 has sufficient fuel to reach a destination.

The programmer 124 also allows the user of the mobile device 106 to input calendar events, such as upcoming trips with the vehicle 102. The user can input other options, such as a fuel brand preferences, refuel time preferences (e.g., with respect to time of day), refuel location preferences (e.g., the user's home, rest stops, etc.), and/or whether the user prioritizes fuel cost over an availability of a fuel provider such as the fuel provider 112 of FIG. 1. The user application 120 includes a database 126 to store the user inputs. The user application 120 also includes a communicator 128. The communicator 128 transmits the data stored in the database 126, such as the fuel level trigger(s), the scheduled calendar events, etc., to the first processor 104 of the vehicle 102.

The data transmitted by the communicator 128 of the user application 120 to the first processor 104 of the vehicle 102 is processed by a fuel manager 130. As will be disclosed below, the fuel manager 130 monitors the fuel level of the vehicle 102, identifies an availability of one or more fuel providers 112, and predictively generates requests for on-demand fuel delivery. To identify the availability of a fuel provider 112, the fuel manager 130 receives scheduling information from an availability tracker 132 of the third processor 116 of the fuel provider 112 via the wireless communication link 114 between the first processor 104 of the vehicle 102 and the third processor 116 of the fuel provider 112.

The fuel manager 130 communicates with the second processor 110 of the mobile device 106 to alert the driver to refueling events via the user application 120. The fuel manager 130 sends the request for on-demand fuel delivery to the mobile device 106 via the wireless communication link 108 between the first processor 104 of the vehicle 102 and the second processor 110 of the mobile device 106. As will be disclosed below, the user can accept, reject, or modify the request via the GUI 122. If the user accepts the request as generated by the fuel manager 130 (or modifies and then accepts the request), a refuel requester 134 of the user application 120 transmits the request to the fuel provider 112 via the wireless connection link 118 between the second processor 110 of the mobile device 106 and the third processor 116 of the fuel provider 112.

Upon receiving the fuel request from the user application 120, the fuel provider 112 delivers the fuel to the vehicle 102. The third processor 116 of the fuel provider 112 includes a fuel monitor 136, which collects data about the refueling event, such as the cost of refueling and the amount of fuel delivered. The fuel provider 112 wirelessly transmits the fueling event data collected by the fuel monitor 136 to the first processor 104 of the vehicle 102, where the fueling event data is received and stored by the fuel manager 130.

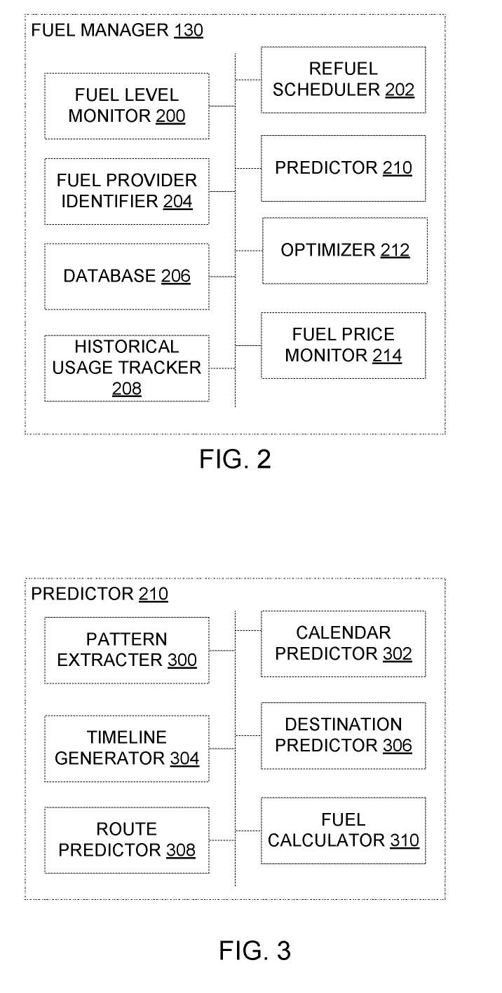

FIG. 2 is a block diagram of the example fuel manager 130 of FIG. 1. The fuel manager 130 includes a fuel level monitor 200. The fuel level monitor 200 monitors the fuel level of the vehicle 102 of FIG. 1 and compares the detected fuel level to the fuel level trigger input by the user of the mobile device 106 via the user application 120. In some examples, the fuel level monitor 200 substantially continuously monitors the vehicle fuel level. In other examples, the fuel level monitor 200 checks the fuel level at predefined time intervals or events, such as the receipt of data from the user application 120 indicating that a trip is planned. If the fuel level of the vehicle 102 is below the fuel level trigger, the fuel level monitor 102 communicates with a refuel scheduler 202 of the fuel manager 130 to automatically generate a request to refuel the vehicle 102.

Upon receiving a notification from the fuel level monitor 200 that the fuel level of the vehicle 102 is below the fuel level trigger, the refuel scheduler 202 communicates with a fuel provider identifier 204 of the fuel manager 130. The fuel provider identifier 204 identifies one or more fuel providers, such as the fuel provider 112 of the FIG. 1, that are available to provide on-demand fueling services to the vehicle 102. The fuel provider identifier 204 can identify the fuel provider(s) 112 based on global positioning satellite (GPS) information with respect to a current location of the vehicle 102 and fuel provider(s) 112 in a geographical vicinity of the vehicle. In some examples, the geographical vicinity of the fuel provider(s) 112 with respect to the current location of the vehicle 102 is set by the user via the user application 120. For example, the user can input a distance range for which the user would like the fuel provider identifier 204 to identify fuel providers (e.g., within 10 miles of the current location of the vehicle's location). In other examples, the fuel provider identifier 204 determines a search distance range based on the GPS information. In some examples, the fuel provider identifier 204 also identifies gas stations in the geographical vicinity of the vehicle 102.

The fuel provider identifier 204 also identifies availability of the fuel provider(s) 112, such as where and when the fuel provider(s) 112 are available to deliver fuel to the vehicle 102. For example, the fuel provider identifier 204 communicates with the availability tracker 132 of the third processer 116 of the fuel provider 112 of FIG. 1 to identify the availability of the fuel provider 112. The fuel provider identifier 204 can receive scheduling information from the availability tracker 132. For example, the availability tracker 132 can send information such as available time slots, available fuel brands, fuel costs, etc. to the fuel provider identifier 204 of the fuel manager 130 via the wireless communication link 114 between the first and third processors 104, 116.

The refuel scheduler 202 also communicates with a database 206 of the fuel manager 130. The database 206 stores the user preferences inputted by the user via the user application 120 and transmitted to the fuel manager 130, such as preferred fuel brand or refueling time. The database 206 also stores information such as environmental restrictions enacted by government agencies with respect to fueling of vehicles. For example, a state may designate certain days of the week as days on which refueling must occur at night. The database 206 also stores information related to fuel price variations between geographical locations, such as average gas prices or whether one city has higher taxes than another city. In some examples, the database 206 stores information about the fuel provider(s) 112 identified by the fuel identifier 204, such as fuel brand carried by the fuel provider(s) 112. The database 206 also includes a calendar to store data related to holidays, which can affect fuel prices.

The refuel scheduler 202 queries the database 206 to determine if there are any preferences, restrictions, etc. that may determine when refueling of the vehicle 102 should be scheduled. Based on the detection of the current fuel level as being below the fuel level trigger by the fuel level monitor 200, the identification of available fuel provider(s) 112 by the fuel provider identifier 204, and the information in the database 206, the refuel scheduler 202 automatically generates a refuel request or reminder for on-demand delivery of fuel. The request can include, for example, the name of the fuel provider 112, the refueling location, an available or estimated time window for refueling, cost, etc. For example, if the user has a preferred fuel brand and preferred refueling time and the fuel provider 112 of FIG. 1 is available at the preferred time and offers the preferred fuel brand, then the refuel scheduler 202 generates a request for the fuel provider 112 to deliver fuel to the vehicle 102. In some examples, the refuel request does not include a proposed time window for refueling or fuel provider 112, but is a notification that the vehicle 102 requires fuel. Also, in some examples, if an on-demand fuel provider 112 is not available, the request can include a list of gas stations in the vicinity of the vehicle 102.

The refuel scheduler 202 sends the request to the user application of the mobile device 106. The user views the refuel request generated by the refuel scheduler 202 of the fuel manager 130 on the mobile device 106 via the GUI 122. The user can accept, reject, or modify the request via the GUI 122. If the user accepts the request as generated by the refuel schedule 202 of the fuel manager 130, or modifies and then accepts the request, the refuel requester 134 of the user application 120 of FIG. 1 transmits the request to the fuel provider 112 via the wireless connection link 118 between the second processor 110 of the mobile device 106 and the third processor 116 of the fuel provider 112.

In some examples, the user can modify the request by rescheduling the fuel delivery time or day via the user application 120. For example, the refuel scheduler 204 can propose or estimate an available time slot for refueling while also providing the user with additional time slots based on the availability of the fuel provider 112. In other examples, the user can request a different fuel provider 112 if more than one fuel provider 112 is identified by the fuel provider identifier 204. The user can also reject the request if, for example, the user does not plan to use the vehicle 102. If the user rejects the request generated by the refuel scheduler 202, the refuel scheduler 202 can generate a new request with, for example, a different fuel provider 112, location, time window, etc. In other examples, if the user rejects the request generated by the refuel scheduler 202, the refuel scheduler 202 provides a list of gas stations in the geographical vicinity of the vehicle 102 and/or does not generate a new refuel request. Also, in examples where the refuel request does not include a proposed refuel time window, the user can view and/or close the notification or reminder via the GUI 122.

Thus, when the fuel level of the vehicle 102 is below the fuel level trigger set by the user via the user application 120, the fuel manager 130 automatically generates a request or reminder to refuel the vehicle via an on-demand fuel provider 112 without requiring the user to monitor the fuel level and/or generate the request. Rather, the user accepts, rejects, or modifies the refueling request after the fuel level has been detected and the request has been automatically generated by the fuel manager 130, thereby substantially reducing the need for the user to monitor fuel levels and/or initiate refueling requests.

As disclosed above, in examples where the user has entered a fuel level trigger, the fuel manager 130 of the vehicle 102 automatically generates a request for refueling of the vehicle 112 by an on-demand fuel provider 112 when the current fuel level is below the fuel level trigger. The fuel manager 130 can also automatically generate a refuel request or reminder based on a predictive analysis performed by the fuel manager 130 with respect to scheduling refueling events for the vehicle 102. The predictive analysis performed by the fuel manager 130 is based on, for example, historical usage data for the vehicle 102 as well as anticipated vehicle usage.

The example fuel manager 130 includes a historical usage tracker 208. The historical usage tracker 208 uses GPS information to collect data about the habits of the driver of the vehicle 102 based on one or more previous vehicle usage events. The data collected by the historical usage tracker 208 includes frequently visited destinations or destinations the driver or user has saved via, for example, the user application 120 or the first processor 104 of the vehicle 112; route(s) that the driver of the vehicle 102 takes to a destination; frequency of the driver taking one route to a destination over another route to the same destination; drive times, or how long for the vehicle 102 to reach a destination; and stop duration, or how long the vehicle 102 remains at a destination before the user uses the vehicle 102 again. Other data collected by the historical usage tracker 208 relate to driver behavior, such as how frequently the user uses the vehicle 102 on weekdays versus weekends, what times the driver uses the vehicles 102 on weekdays versus weekends, whether the driver uses the vehicle for long trips on the weekends or short local trips, how many destinations a driver visits when using the vehicle, and how often the driver refuels the vehicle. The historical usage tracker 208 collects data about the amount of fuel used by the vehicle 102 based on, for example, the destination and/or the route. The data collected by the historical usage tracker 208 is stored by the database 206.

The fuel manager 130 includes a predictor 210. As will be disclosed below, the predictor 210 uses the data collected by the historical usage tracker 208 to extract patterns about the usage of the vehicle 102, predict when the vehicle 102 will be used, predict the destination(s) the vehicle 102 will be driven to, and estimate fuel consumption based on the predictions. The fuel manager 130 also includes an optimizer 212 to optimize the predictive scheduling of on-demand refueling events based on the historical vehicle usage data and the anticipated vehicle usage. Based on the predictive analysis performed by the predictor 210 and the optimization of the analysis by the optimizer 212, the fuel scheduler 202 generates refueling requests to send to the user of the mobile device 106.

In some examples, the scheduling of one or more refuel requests by the fuel manager 130 is driven by fuel cost. The example fuel manager 130 includes a fuel price monitor 214. The fuel price monitor 214 monitors fuel prices based on, for example, information received from one or more fuel provider(s) 112. For example, the fuel provider(s) 112 can transmit fuel prices for different fuel brands to the fuel price monitor 214 via the wireless communication link 114 between the first processor 104 of the vehicle 102 and the third processor 116 of the fuel provider 112. Thus, the fuel price monitor 214 can receive real-time or substantially real-time fuel prices. The fuel price monitor 214 compares the fuel price(s) to the fuel price trigger input by the user of the mobile device 106 via the user application 120. If the fuel prices monitored by the fuel price monitor 214 are below the fuel price trigger, the fuel price monitor 214 communicates with the refuel scheduler 202 to automatically generate a refuel request for the vehicle 102 substantially as disclosed above with respect to the generation of the refuel request upon detection that the fuel level is below the fuel level trigger.

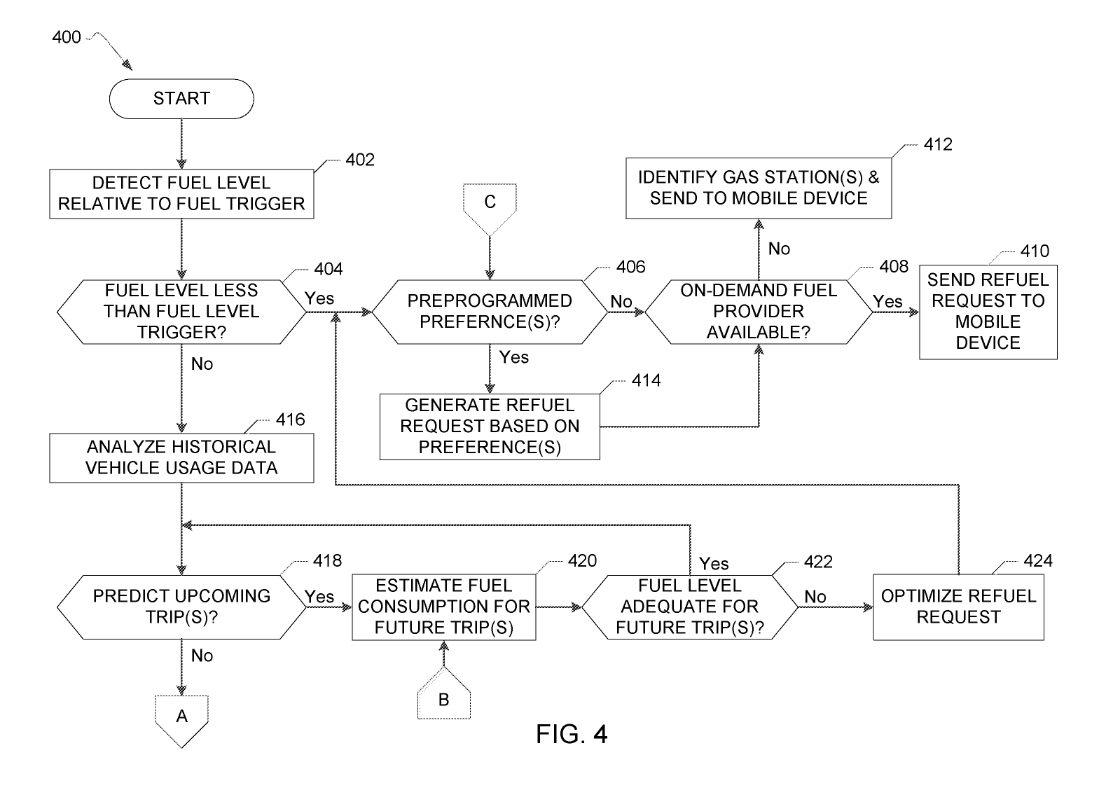

As disclosed above, the fuel manager 130 generates refuel requests based on a predictive analysis of when the vehicle 102 will need fuel in view of historical vehicle usages data or scheduled trips input by the user. FIG. 3 is a block diagram of the example predictor 210 of FIG. 2. The example predictor 210 includes a pattern extractor 300. The pattern extractor 300 identifies or recognizes patterns in the vehicle usage data collected by the historical usage tracker 208. For example, the pattern extractor 300 recognizes that on weekdays, the user drives the vehicle 102 from home to work in the morning and from work to home in the afternoon. In some examples, the pattern extractor 300 also recognizes that if the user leaves home between 7 and 7:15 a.m., the user takes a first route to work, while if the user leaves home between 7:45 and 8 a.m., the user takes a second, different route to work. In some examples, the pattern extractor 300 recognizes that on the weekends, the user does not use the vehicle 102 until after 10 a.m. In other examples, the pattern extractor 300 recognizes that the user uses the vehicle 102 to take a long-distance trip once a month. The pattern extractor 300 can also identify trends or patterns with respect to fuel consumption based on different routes.

The example predictor 210 uses the patterns identified by the pattern extractor 300 to predict a future vehicle usage event for the vehicle 102, including, for example, destination, route, and trip timing. To predict the future usage of the vehicle 102, the predictor 210 employs one or more analysis techniques, including, for example, Markov models, clustering, and/or fuzzy partitions. The predictor 210 also analyzes similarity patterns with respect to, for example, daily usage of the vehicle 102 and/or identifies frequent routes of the vehicle 102 using data mining techniques. The example predictor 210 uses one or more algorithms to predict future usage of the vehicle 102 substantially as described in U.S. application Ser. No. 13/400,304; U.S. application Ser. No. 13/714,919; U.S. application Ser. No. 13/855,973; U.S. application Ser. No. 14/249,931; U.S. application Ser. No. 14/514,753; and the publication “Contextual On-Board Learning and Prediction of Vehicle Destination,” by Dimitar Filev et al. published in the 2011 IEEE Symposium on Computational Intelligence in Vehicles and Transportation Systems at pp. 87-91, each of which is incorporated herein by reference.

For example, the predictor 210 includes a calendar predictor 302. The calendar predictor 302 predicts when the vehicle 102 will be used based on, for example, the patterns identified with respect to the usage of the vehicle on weekdays and weekends. In some examples, the calendar predictor 302 obtains data from the database 206 of FIG. 2 to identify an upcoming holiday and predicts that the vehicle 102 will be used based on the usage data for previous holidays, as identified by the pattern extractor 300.

The example predictor 210 includes a timeline generator 304. The timeline generator 304 predicts a time of day when the vehicle will be used, including a start time when the vehicle 102 will be used to reach the destination. For example, if the calendar predictor 302 predicts that the vehicle 102 will be used on a weekday, the timeline generator 304 may determine that the vehicle 102 will be used between the hours of 7 a.m. and 8 a.m. and 5 and 6 p.m. based on the weekday driving patterns identified by the pattern extractor 300. The timeline generator 304 also determines that the vehicle 102 is not used for eight-hour periods of time during the weekdays (e.g., while the user is at work), or, put another way, that an expected stop duration is eight hours. In examples where the calendar predictor 302 predicts that the vehicle 102 will be used on a weekend day, the timeline generator 304 may estimate that the stop duration of the vehicle at a destination will be shorter than the weekday (e.g., because the user is running errands). Thus, the timeline generator 304 identifies a likelihood that the vehicle 102 will be used at a particular time of day and an expected stop duration when the vehicle arrives at a destination.

The example predictor 210 includes a destination predictor 306 and a route predictor 308. The destination predictor 306 predicts a destination of the vehicle 102 based on the usage of the vehicle 102 predicted by the calendar predictor 302 and/or the timeline generator 304. For example, if the calendar predictor 302 predicts that the vehicle 102 will be used on a weekday, the destination predictor 304 may predict that the vehicle 102 will be driven to work based on a frequency of the user's workplace as a destination during the weekday, as identified by the pattern extractor 300.

The route predictor 308 predicts a probability or likelihood that a user will take a certain route to the predicted destination over another route. For example, based on the expected time (e.g., a starting time) the vehicle is to be used to reach a particular destination, as determined by the calendar predictor 302, the timeline generator 304, and the destination predictor 306, the route predictor 308 predicts that the user will take a first route to the destination rather than a second route. The route predictor 308 uses the patterns identified by the pattern extractor 300 with respect to frequency of route usages and transitions between destinations to predict a route of the vehicle 102 to the predicted destination.

Based on the determinations by the calendar predictor 302, the timeline generator 304, the destination predictor 306, and/or the route predictor 308 with respect to future usage of the vehicle 102, the predictor 210 estimates fuel consumption by the vehicle 102 to reach the predicted destination. To estimate the fuel consumption, the predictor 210 includes a fuel calculator 310. For example, the fuel calculator 310 calculates the fuel consumption based on the predicted route and the expected starting time for the trip, which can affect traffic and, thus, the length of the drive time. In some examples, the fuel calculator 310 accounts for the patterns identified by the pattern extractor 300 with respect to fuel consumption per route.

To determine whether the vehicle 102 has a sufficient amount of fuel to travel to the destination predicted by the predictor 210 along the predicted route, the fuel consumption determined by the fuel calculator 310 is compared to the current fuel level by the fuel level monitor 200 of the fuel manager 130 of FIG. 2. If the fuel level monitor 200 determines that, based on the current fuel level, the vehicle 102 does not have enough fuel to reach the predicted destination, the fuel monitor 200 communicates with the refuel scheduler 202 to automatically generate a refuel request or reminder for the vehicle 102 to be transmitted to the mobile device 106. As part of the scheduling of on-demand refueling events based on the predictive data generated by the predictor 210, the refuel scheduler 202 communicates with the optimizer 212.

The optimizer 212 receives information from the predictor 210 regarding the predicted travel timeline (e.g., weekday versus weekend), destination, route, stop duration, etc. The optimizer 212 receives information from the database 206, such as upcoming holidays and price variations between geographical locations. The optimizer 212 also receives information related to user preferences input via the user application 120, such as fuel brand preference and fuel level trigger settings (e.g., the fuel lever trigger indicating that the user wishes to refuel the vehicle as soon as possible). The optimizer 212 is in communication with the fuel level monitor 200, the refuel scheduler 202, the fuel provider identifier 204, the database 206, and the historical usage tracker 208 and, thus, considers data collected and processed by the fuel manager 130 to optimize the predictive scheduling of the refueling event.

For example, the predictor 210 can predict that on a weekday, the vehicle 102 will be driven to the user's workplace and then to one other destination before returning to the user's home. The fuel calculator 310 of the predictor 210 determines that the vehicle 102 has sufficient fuel to reach the user's workplace but will need to be refueled to reach the user's home. Based on the prediction by the predictor 210 that the vehicle 102 will be driven to work with a stop duration of eight hours and data from the database 206 that fuel prices will be lower at night than in the morning, the optimizer 212 generates a refuel request scheduling the refueling to occur after the user leaves work but before the user returns home. Thus, the optimizer 212 leverages price drops by scheduling the refueling to occur later in the day, when gas prices are lower. The optimizer 212 determines a timeline for fuel delivery that accounts for the predicted stop duration, thereby providing for increased flexibility in identifying the availability of the fuel provider(s) 112.

As another example, the optimizer 212 evaluates the route predicted by the route predictor 308 of the predictor 210 and determines that the vehicle 102 will be passing through a first geographical area and a second geographical area along the route. Based on the data stored in the database 206 with respect to fuel price variations between geographical locations, the optimizer 212 determines that gas prices in the first geographical location are, on average, lower than the gas prices in the second geographical location. The optimizer 212 generates a refuel request that schedules the refueling to occur while the vehicle 102 is in the first geographical area to take advantage of the lower fuel costs, even if the vehicle 102 will not need to be refueled until the vehicle 102 is in the second geographical area.

As another example, if the predictor 210 predicts that the vehicle 102 will be used on a long-distance trip over a holiday weekend, the optimizer 212 may generate a refuel request for refueling the vehicle 102 on a weekday before the holiday weekend to leverage lower gas prices, even if the vehicle 102 does not need fuel until the weekend. In some examples, the optimizer 212 generates a first notice or reminder about the upcoming holiday that is transmitted to the user application 120. The first notice can include a request for the user to confirm whether he would like to refuel the vehicle in advance of the holiday. If the user accepts the first notice, the optimizer 212 can schedule the refueling event to occur before the holiday based on an analysis of fuel prices in the days leading up to the holiday. Thus, the optimizer 212 anticipates variations in, for example, price costs, to generate refuel requests that benefit the user by refueling earlier than needed.

In some examples, the optimizer 212 balances the scheduling of refueling events with user preferences and/or historical vehicle usage data. For example, if the user has indicated a fuel brand preference, the optimizer 212 may give the fuel brand preference more weight over fuel cost. As another example, if the historical vehicle usage data indicates that the user prefers to minimize stops on long-distance drives, the optimizer 212 may schedule the refueling event to maximize drive time, even if the vehicle 102 will pass through a geographical area with low fuel costs.

As disclosed above, the optimizer 212 uses the predictions generated by the predictor 210 with respect to destination and route to schedule refueling events that leverage price variations, availability of the fuel provider(s) 112, etc. In some examples, the user inputs a destination and/or a route via the user application 120. In such examples, the optimizer 212 determines when to schedule refueling events based on user inputs.

For example, the user can input a route to a destination via the user application 120 and designate certain locations along the route where the user plans to stop, such as a stop in a city along the route for an overnight stay. Based on the information about the planned stops, the optimizer 212 determines at which stops the vehicle 102 should be refueled. To make this determination, the optimizer 212 communicates with, for example, the fuel level monitor 200 and/or the predictor 210, which can estimate when the vehicle 102 will require refueling based on the route. In examples where the user does not enter planned stops along the route, the optimizer 212 can identify refueling stops in view of factors such as fuel price variations between geographical locations along the route and/or driving habits identified from the historical vehicle usage data, indicating that the user typically avoids driving more than two hours without stopping.

Thus, the predictor 210 and/or the optimizer 212 of the fuel manager 130 provide automatic scheduling of refueling events that are sensitive to, for example, weekday trips versus weekend trips, trips in the morning hours versus the night hours, routes, destinations, and stop durations. The predictor 210 and/or the optimizer 212 anticipate driving events with respect to the vehicle 102, such as expected route to schedule refueling events based on historical vehicle usage data and external factors, such as holidays. In accounting for historical vehicle usages as well as predicted future vehicle usage, the fuel manager 130 automatically schedules refueling events that are customized to the driving behavior of the user with respect to the vehicle 102.

As disclosed above, the fuel manager 130 can generate a refuel request based on, for example, detecting that the fuel level of the vehicle 102 is below the fuel lever trigger, predicting when the vehicle 102 will need fuel in view of historical vehicle usage data or scheduled trips input by the user, and/or detecting that fuel prices have dropped below a fuel price trigger. Based on input from the fuel level monitor 200, the fuel provider identifier 204, the predictor 210, the optimizer 212, and/or the fuel price monitor 214, the refuel scheduler 202 generates the refuel request or notification and transmits the request to the mobile device 106 for viewing by the user. The refuel request can include, for example, one or more proposed refuel time windows during the predicted drive time along the predicted route. In other examples, the refuel request includes a notification of an upcoming holiday or a drop in fuel prices and includes a request to refuel the vehicle 102 to take advantage of the price drop. As disclosed above, the user can accept, modify, or reject the request generated by the refuel scheduler 202 of the fuel manager 130. If the user accepts the request or modifies and then accepts the refuel request, the refuel request is wirelessly transmitted to the fuel provider 112 via the refuel requester 134 of the user application 120.

Also, in some examples, the refuel scheduler 202 transmits information used to generate the refuel request, such as the user's preferred fuel brand, and/or the information contained in the refuel request, such as the proposed refuel time window, to one or more of the fuel provider(s) 112. The information can be transmitted via the wireless communication link 114 between the first processor 104 of the vehicle 102 and the third processor 116 of the fuel provider 112. Such information can be used by the fuel provider(s) 112 for advertising or promotional purposes, including targeted advertising to the user of the mobile device 106 (e.g., via the wireless communication link 118 between the second processor 110 of the mobile device 106 and the third processor 116 of the fuel provider 112). In some examples, the fuel provider(s) 112 use the information received from the refuel scheduler 202 to bid for the business of the user of the mobile device 106 based on, for example, the user's preferred refuel time window.

Referring again to FIG. 1, upon receiving the fuel request from the user application 120, the fuel provider 112 delivers the fuel to the vehicle 102 at the scheduled time and location. The fuel monitor 136 of the third processor 116 of the fuel provider 112 collects data about the refueling event. For example, the fuel monitor 136 records data such as the amount of fuel provided to the vehicle 102, the cost of the refueling, and the fuel brand. The fuel provider 112 wirelessly transmits the fueling event data collected by the fuel monitor 136 to the first processor 104 of the vehicle 102, where the fueling event data is received by the fuel manager 130 and stored in the database 206 and/or the historical usage tracker 208. In other examples, the vehicle 102 automatically detects that the vehicle has been refilled based on an amount of gas in a gas tank of the vehicle and transmits the fuel amount to the fuel manager 130.

In some examples, based on the data received for a refueling event, the fuel manager 130 automatically updates the predictive scheduling of future refuel events and/or generates a new refueling request for a future refueling event. For example, if the user adjusted the time window for refueling the vehicle 102 such that the vehicle 102 used more fuel than the predictor 210 estimated before the refueling, the predictor 210 automatically adjusts the fuel consumption calculation performed by the fuel calculator 310. The optimizer 212 automatically adjusts the determination of where the next refuel location should be scheduled based on the amount of fuel delivered at the previous refueling event, the geographic location of the previous refueling event, the user preferences, etc.

Thus, the example system 100 provides for automatic scheduling of refueling events based on historical and predictive vehicle usages data as well as factors such as fuel costs and fuel provider availability. The example system 100 provides for efficient communication between the processor 104 of the vehicle 102, the mobile device 106, and the fuel provider 112, in that the refueling analysis is performed at the vehicle 102 and a refuel request or reminder is generated at the vehicle 102 based on the analysis. Rather than transmitting the raw vehicle data to the mobile device 106, which creates inefficiencies with respect to, for example, bandwidth usage and data storage, the first processor 104 transmits only the refuel request, including information such as proposed refuel time and location information. Further, the example system 100 automatically updates the scheduling analysis based on data about the refueling event received from the fuel provider 112.

While an example manner of implementing the example system 100 is illustrated in FIGS. 1-3, one or more of the elements, processes, and/or devices illustrated in FIGS. 1-3 may be combined, divided, rearranged, omitted, eliminated, and/or implemented in any other way. Further, the example the first processor 104, the second processor 110, the third processor 116, the user application 120 (including the programmer 124, the database 126, the communicator 128, and/or the refuel requester 134), the fuel manager 130 (including the fuel level monitor 200, the refuel scheduler 202, the fuel provider identifier 204, the database 206, the historical usage tracker 208, the predictor 201, the optimizer 212, the pattern extractor 300, the calendar predictor 302, the timeline generator 304, the destination predictor 306, the route predictor 308, and/or the fuel calculator 310), the availability tracker 132, and/or the fuel monitor 136 may be implemented by hardware, software, firmware, and/or any combination of hardware, software, and/or firmware. Thus, any of the example the first processor 104, the second processor 110, the third processor 116, the user application 120 (including the programmer 124, the database 126, the communicator 128, and/or the refuel requester 134), the fuel manager 130 (including the fuel level monitor 200, the refuel scheduler 202, the fuel provider identifier 204, the database 206, the historical usage tracker 208, the predictor 201, the optimizer 212, the pattern extractor 300, the calendar predictor 302, the timeline generator 304, the destination predictor 306, the route predictor 308, and/or the fuel calculator 310), the availability tracker 132, and/or the fuel monitor 136 and/or, more generally, the example system 100 could be implemented by one or more analog or digital circuit(s), logic circuits, programmable processor(s), application-specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example the first processor 104, the second processor 110, the third processor 116, the user application 120 (including the programmer 124, the database 126, the communicator 128, and/or the refuel requester 134), the fuel manager 130 (including the fuel level monitor 200, the refuel scheduler 202, the fuel provider identifier 204, the database 206, the historical usage tracker 208, the predictor 201, the optimizer 212, the pattern extractor 300, the calendar predictor 302, the timeline generator 304, the destination predictor 306, the route predictor 308, and/or the fuel calculator 310), the availability tracker 132, and/or the fuel monitor 136, are hereby expressly defined to include a tangible, computer-readable storage device or storage disk, such as a memory, a digital versatile disk (DVD), a compact disk (CD), a Blu-ray disk, etc. storing the software and/or firmware. Further still, the example system of FIGS. 1-3 may include one or more elements, processes, and/or devices in addition to, or instead of, those illustrated in FIGS. 1-3, and/or may include more than one of any or all of the illustrated elements, processes, and devices.

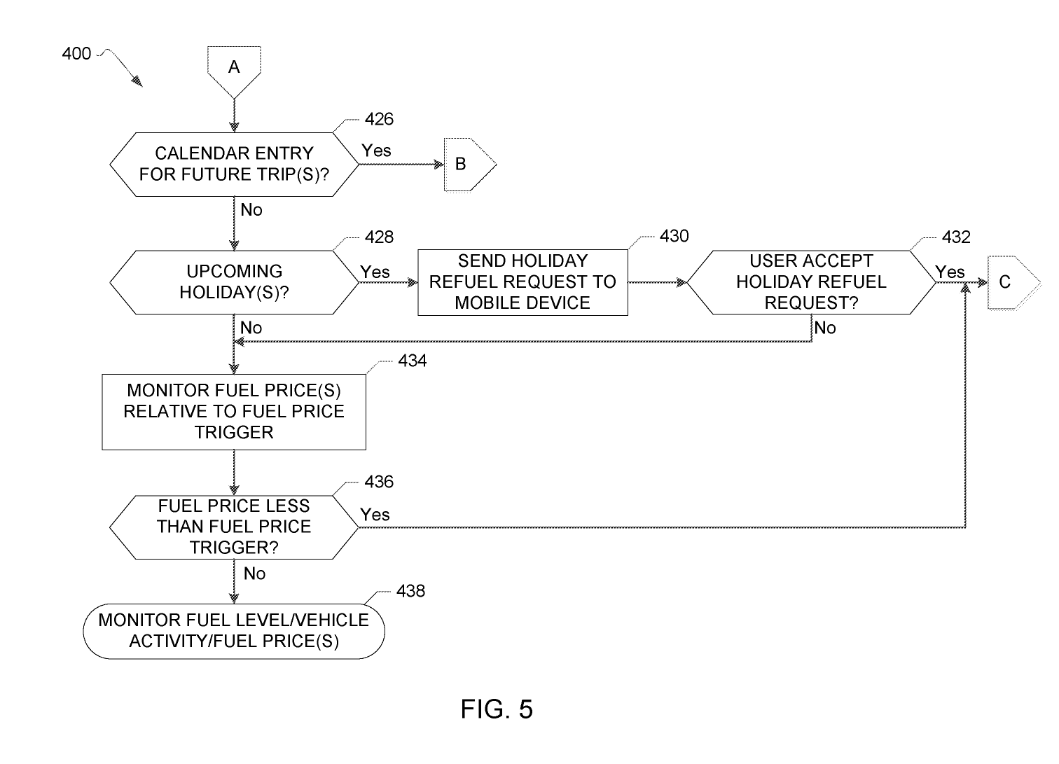

FIGS. 4-5 illustrate flowcharts representative of an example method 400 that can be implemented to automatically generate on-demand refueling requests or reminders for a vehicle to be sent to a user of a mobile device. Although the example method 400 will be disclosed below in connection with refueling of a vehicle operating with gasoline, the example method of FIGS. 4-5 can also be used to manage refueling a vehicle with any other fuel. The example method 400 can be implemented using the fuel manager 130 of the vehicle 102 and the user application 120 of the mobile device 106 of FIGS. 1-3. The example method 400 begins with detecting a fuel level of a vehicle (block 402). The fuel amount can be detected by the fuel level monitor 200 of the fuel manager 130 of FIGS. 1 and 2.

The example method 400 includes a determination of whether the fuel level is less than the fuel level trigger (block 404). The fuel level trigger can be set by a user via the user application 120 of the mobile device 106 of FIG. 1 and transmitted to the fuel manager 130 via the communicator 128 of the user application 120. The fuel level trigger can represent a fuel amount at which the user wishes to refuel the vehicle. If the fuel level of the vehicle is less than the fuel level trigger, the example method 400 includes determining whether there are any preprogrammed preferences, such as a preferred fuel brand for the vehicle, preferred refueling location, and/or preferred refueling time (block 406). The preprogrammed preferences can also include environmental restrictions on refueling set by government agencies. In some examples, the preprogrammed preferences are input by the user of the mobile device 106 via the user application 120 and transmitted to the fuel manager 130, where they are stored in the database 206 of FIG. 2. In other examples, the fuel manager 130 is programmed to include the user's preferences, such as environmental restrictions.

If there are no preprogrammed preferences, the example method 400 continues with determining whether an on-demand fuel provider is available to deliver fuel to the vehicle (block 408). In some examples, the fuel provider identifier 204 identifies one or more on-demand fuel providers 112 in a geographical vicinity of the vehicle 102 that are available to deliver fuel to the vehicle. If a fuel provider 112 is available to deliver fuel to the vehicle, the example method 400 includes sending a refuel request to a mobile device for viewing by the user of the mobile device (block 410). The refuel request can be generated by the refuel scheduler 202 of FIG. 2 and include, for example, a proposed refuel time window and location. If an on-demand fuel provider is not available to deliver fuel to the vehicle, the example method 400 includes identifying one or more gas stations in the vicinity of the vehicle and sending the identified gas stations to the mobile device for viewing by the user (block 412).

If there are any preprogrammed preferences determined at block 406, such as preferred refuel time or location or government-imposed environmental restrictions on refueling, the example method 400 includes generating the refuel request based on the user preference(s) (block 414). For example, if the user has entered a preferred refuel location, the refuel scheduler 202 may generate a refuel request for the vehicle to be refueled at the preferred location. The example method 400 continues with identifying available on-demand fuel providers in accordance with the preprogrammed preference(s) and sending the request (of available gas stations) to the user of the mobile device for review (blocks 408, 410, 412).

As disclosed above, the example method 400 generates refuel requests or reminders based on a determination that a fuel level of the vehicle is below a fuel level trigger. The example method 400 also generates refuel requests based on a predictive analysis, using vehicle usage data to predict when the vehicle will need to be refueled (or recharged in the case of electric or hybrid electric vehicles). The predictive analysis of the example method 400 can be performed by the predictor 210 of the fuel manager 130 of FIGS. 1-3.

In the example method 400, if the fuel level of the vehicle is not less than the fuel level trigger as determined at block 404, the example method 400 continues with analyzing historical vehicle usage data (block 416). The historical vehicle usage data can include prior routes taken and destinations reached using the vehicle based on, for example, GPS data. The historical vehicle usage data can be collected by the historical usage tracker 206 of FIG. 2. The analysis of the historical vehicle usage data includes identifying patterns and/or trends with respect to the usage of the vehicle. The analysis of the vehicle usage data can be performed by the pattern extractor 300 of FIG. 3.

Based on the analysis of the vehicle usage data, the example method 400 includes a determination of whether an upcoming or future vehicle usage event, such as one or more trips with the vehicle, is expected to occur (block 418). The determination of whether an upcoming trip is expected to occur can include a prediction of whether the trip is expected to occur on a weekday or a weekend, what time of day the trip is predicted to occur, the predicted destination, the predicted route, the predicted drive time to the destination, and/or the stop duration when the destination is reached. The prediction of an upcoming trip can be performed by the calendar predictor 302, the timeline generator 304, the destination predictor 306, and/or the route predictor 308 of the example predictor 210 of FIGS. 2 and 3.

If an upcoming trip using the vehicle is expected, the example method 400 continues with estimating fuel consumption by the vehicle to complete the predicted trip (block 420). The estimate of the fuel consumption can be based on, for example, distance to the predicted destination, the predicted route, the predicted drive time, etc. The fuel calculator 310 of FIG. 3 can calculate an amount of fuel needed by the vehicle to reach the predicted destination along the predicted route.

The example method 400 includes determining whether a fuel level of the vehicle is adequate for the vehicle to reach the predicted destination in view of the predicted fuel consumption (block 422). In the example method 400, the predicted fuel consumption is compared to the current fuel level of the vehicle by the fuel level monitor 200 of the fuel manager 130. If a determination is made that the vehicle will not have sufficient fuel to reach the predicted destination, the example method 400 continues with optimizing a refuel request (block 424).

Optimizing the refuel request based on the predictive analysis performed at block 418 includes, for example, identifying fuel prices in different geographical areas along the predicted route and predictively scheduling a refuel to occur in the geographical area having the lowest fuel prices. As another example, if the vehicle needs fuel but will remain at a destination for several hours before being used again, the optimization of the refuel request may include scheduling the refueling for later in the day rather than as soon as possible to, for example, leverage lower gas prices or increase flexibility with respect to fuel provider availability. The optimization of the refuel request can be performed by the optimizer 212 of FIG. 2.

After the prediction and optimization of the refuel request has been performed, the example method 400 continues with generating the refuel request based on preprogrammed preferences (blocks 406, 414) and/or identification of on-demand fuel providers (block 408) available to provide fuel to the vehicle along the predicted route and in view of the estimated fuel consumption. The example method 400 includes sending the fuel request generated based on the predictive analysis (or gas stations) to the user for review via the mobile device.

If the fuel level of the vehicle is adequate to reach the predicted destination, the example method 400 continues with predicting upcoming trips based on the vehicle usage data. Referring to FIG. 5, if an upcoming trip is not expected to occur (block 412 of FIG. 4), the example method 400 continues with determining whether the user has scheduled one or more upcoming trips via the mobile device (block 426). For example, the user can schedule an upcoming trip by inputting a calendar entry using the user application 120 installed on the mobile device 106. The entry can include the trip destination, route, start time, etc. The scheduled calendar event(s) can be transmitted to the fuel manager 130 of the vehicle 102 via the wireless connection between the first processor 104 of the vehicle 102 and the second processor 110 of the mobile device 106.

If the user inputs a calendar entry for a future trip, the example method 400 returns to block 420 of FIG. 4, where the example method 400 includes estimating fuel consumption for the future scheduled trip. The determination of the fuel consumption for the scheduled trip can be calculated by the fuel calculator 310 of FIG. 3 based on, for example, the user-input destination and route. The example method 400 continues with determining whether the vehicle has sufficient fuel to complete the future scheduled trip (block 422). If the vehicle does not have sufficient fuel to complete the future scheduled trip, the example method 400 continues with optimizing the refuel request based on, for example, an analysis of the user-input route and/or other user preferences, and sending the refuel request to the user for review via the mobile device (blocks 406, 408, 410, 412, 414, 424).

In addition to generating fuel requests based on a prediction of an upcoming trip or entry of a scheduled trip by the user, the example method 400 also provides for the generation of refueling requests based on an analysis of fuel prices. For example, if there is no user-input calendar entry for a future trip at block 426, the example, method 400 continues with determining if there are any upcoming holidays (block 428). The determination of whether there are any upcoming holidays can be made by, for example, the refuel scheduler 202, the predictor 210 (e.g., the calendar predictor 302), and/or the optimizer 212, of the fuel manager 130 of FIGS. 1-3. Gas prices are typically higher over a holiday. Thus, the example method 400 recognizes holidays to allow the user to take advantage of lower gas prices by refueling the vehicle before the holidays.

If a determination is made that there is an upcoming holiday (e.g., a holiday occurring over the next weekend), the example method 400 includes sending a holiday refuel request to the mobile device to notify the user of the upcoming holiday (block 430). In some examples, the holiday refuel request is sent by the optimizer 212 of the fuel manager 130. The holiday refuel request includes a request for the fuel manager 130 to schedule a refueling event for the vehicle in advance of the holiday, even if the fuel level of the vehicle is not below the fuel level trigger and/or if there are no upcoming predicted or scheduled trips.

The example method 400 includes a determination of whether the user has accepted the holiday refuel request by giving permission for the vehicle to be refueled in advance of the holiday (block 432). If the user accepts the holiday refuel request, the example method 400 continues with generating a refuel request based on, for example, preprogrammed preferences of the user and/or environmental restrictions, identifying available on-demand fuel providers, and generating a refuel request for refueling the vehicle (blocks 406, 408, 410, 412, 414).

If there are no upcoming holidays or if the user does not accept the holiday refuel request (e.g., the user prefers not to refuel the vehicle before the holiday), the example method 400 includes monitoring prices for one or more fuel brands (block 434). In particular, the example method 400 includes monitoring the fuel prices relative to a fuel price trigger set by the user via the mobile device. The example method 400 includes determining whether one or more fuel prices are less than the fuel price trigger (block 436). The monitoring of the fuel prices and the comparing of the fuel prices to the fuel price trigger can be performed by the fuel price monitor 214 of FIG. 2. If a determination is made that one or more fuel prices are below the fuel price trigger, the example method 400 includes generating a refuel request based on, for example, preprogrammed preferences of the user and/or environmental restrictions, identifying available on-demand fuel providers, and generating a refuel request for refueling the vehicle (blocks 406, 408, 410, 412, 414). In other examples, the method includes sending a notification to the user via the mobile device that fuel prices have dropped below the fuel price trigger and requesting permission to schedule a refuel event in view of the price drop.

If fuel prices have not dropped below the fuel price trigger, the example method 400 ends with continued monitoring of one or more of the vehicle fuel level, vehicle activity that may affect the predictions of future vehicle usages events or involve newly scheduled events, and fuel prices (block 438). Based on the continued monitoring, the example method 400 may automatically generate and/or update one or more refuel requests and/or update the historical vehicle usage data. Thus, the example method 400 automatically recognizes the refueling needs of the vehicle based on user input threshold levels, scheduled trips, and/or predicted vehicle activity, and generates corresponding refueling requests, thereby minimizing the need for the user to monitor the refueling of the vehicle.

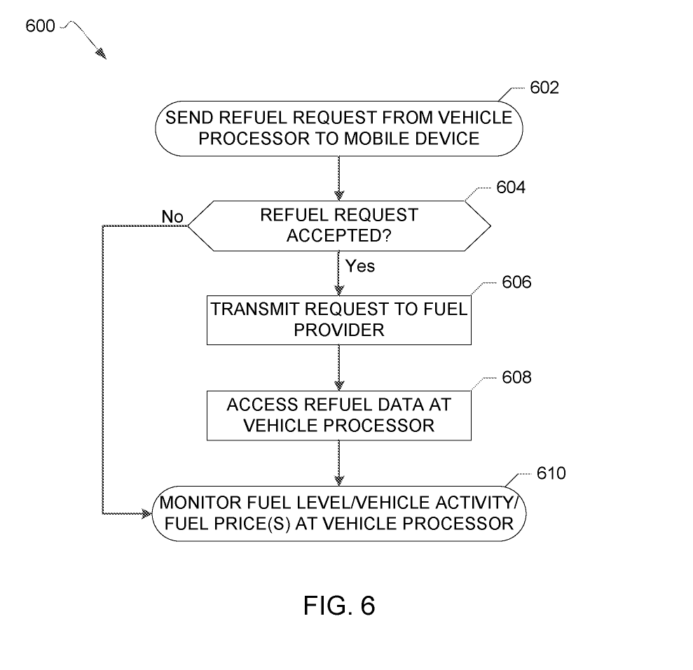

FIG. 6 illustrates a flowchart representative of an example method 600 that can be implemented to schedule on-demand refueling or recharging of a vehicle based on refuel requests generated by the vehicle and transmitted to a mobile device. The example method 600 begins with sending a refuel request from a vehicle processor to a mobile device (block 602). The refuel request can be generated by the refuel manager 130 of the first processor 104 of the vehicle 102 of FIGS. 1-3, as disclosed above in connection with the example method 400 of FIGS. 4 and 5. In the example method 600, the refuel request is transmitted via a wireless connection between the first processor 104 of the vehicle 102 and the second processor 110 of the mobile device 106.

When the refuel request is received by the mobile device (e.g., the second processor 110 of the mobile device 106), the refuel request is viewable via a GUI associated with a user application installed on the mobile device. For example, the refuel request can be viewed on the mobile device 106 of FIG. 1 via the GUI 122 associated with the user application 120. The user can review the refuel request, which may include, for example, one or more proposed time windows and/or locations for refueling the vehicle, information about available fuel providers, requests for early scheduling of refueling events in view of fuel price drops or upcoming holidays, etc. The user can accept or reject the refuel request via the user application 120. In some examples, the user can modify the request, such as the refuel time window or location, via the user application 120, and accept the modified request.

The example method 600 includes determining whether the user has accepted the refuel request (block 604). If the user has accepted the refuel request, the example method 600 includes transmitting the request to a fuel provider (block 606), such as a fuel provider identified by the fuel manager 130 of the vehicle 102 or selected by the user. For example, the refuel requestor 134 of the user application 120 of FIG. 1 can transmit the request to a fuel provider 112 of FIG. 1 via a wireless connection between the second processor 110 of the mobile device 106 and the third processor 116 of the fuel provider 112. Upon receipt of the refuel request, the fuel provider 112 refuels the vehicle at the location and time identified in the request.

The example method 600 includes accessing data related to the refueling of the vehicle (block 608). For example, during and/or after the refueling of the vehicle 102 by the fuel provider 112, the vehicle 102 may detect that the amount of gas in the gas tank has increased and transmit the fuel level to the fuel manager 130. In other examples, the third processor 116 of the fuel provider 112 wirelessly transmits data such as the amount of fuel delivered to the vehicle, time of refueling, the fuel brand, the cost, etc., to the fuel manager 130.

After refueling of the vehicle and receipt of refuel data, the example method 600 ends with continued monitoring of one or more of the vehicle fuel level, vehicle activity that may affect the predictions of future vehicle usages events or involve newly scheduled events, and fuel prices in view of the refueling data received at block 608 (block 610). For example, if the refueling data indicates that the vehicle 102 was refueled with less fuel than expected by the fuel manager 130 of FIGS. 1-3 in generating the refuel request, the fuel manager 130 may recognize that the vehicle 102 needs additional fuel and dynamically generate additional refuel requests and/or adjust predicted refueling needs. Also, if the user does not accept the refuel request at block 604, the example method 600 continues to monitor the fuel levels and/or vehicle activity to provide for continued management of the refueling of the vehicle and notifications to the user.

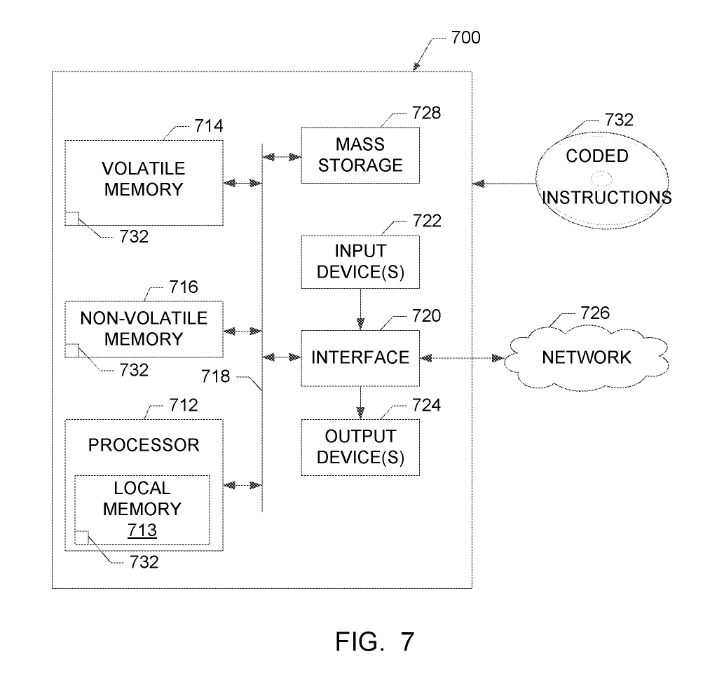

The flowcharts of FIGS. 4-6 are representative of example methods that may be used to implement the example system 100 of FIGS. 1-3. In these examples, the methods may be implemented using machine-readable instructions that comprise a program for execution by a processor such as the processor 712 shown in the example processor platform 700, discussed below in connection with FIG. 7. The program may be embodied in software stored on a tangible, computer-readable storage medium, such as a CD-ROM, a floppy disk, a hard drive, a digital versatile disk (DVD), a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowcharts illustrated in FIGS. 4-6, many other methods of implementing the example system 100 may alternatively be used. For example, the order of execution of the blocks may be changed, and/or some of the blocks described may be changed, eliminated, or combined.

As mentioned above, the example methods of FIGS. 4-6 may be implemented using coded instructions (e.g., computer- and/or machine-readable instructions) stored on a tangible, computer-readable storage medium such as a hard disk drive, a flash memory, a read-only memory (ROM), a compact disk (CD), a digital versatile disk (DVD), a cache, a random-access memory (RAM), and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer-readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 4-6 may be implemented using coded instructions (e.g., computer- and/or machine-readable instructions) stored on a nontransitory computer and/or machine-readable medium, such as a hard disk drive, a flash memory, a read-only memory, a compact disk, a digital versatile disk, a cache, a random-access memory, and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer-readable storage device and/or storage disk and to exclude propagating signals and to exclude transmission media. As used herein, when the phrase “at least” is used as the transition term in a preamble of a claim, it is open-ended in the same manner as the term “comprising” is open-ended.

FIG. 7 is a block diagram of an example processor platform 700 capable of executing instructions to implement the methods of FIGS. 4-6 and the example system 100 of FIGS. 1-3. The processor platform 700 can be, for example, a server, a personal computer, a mobile device (e.g., a cell phone, a smartphone, a tablet such as an iPad™), a personal digital assistant (PDA), an Internet appliance, or any other type of computing device.

The processor platform 700 of the illustrated example includes a processor 712. The processor 1012 of the illustrated example is hardware. For example, the processor 712 can be implemented by one or more integrated circuits, logic circuits, microprocessors, or controllers from any desired family or manufacturer.

The processor 712 of the illustrated example includes a local memory 713 (e.g., a cache). The processor 712 of the illustrated example is in communication with a main memory, including a volatile memory 714, and a nonvolatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM), and/or any other type of random access memory device. The nonvolatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), and/or a PCI express interface.

In the illustrated example, one or more input devices 722 are connected to the interface circuit 720. The input device(s) 722 permit(s) a user to enter data and commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 1024 can be implemented, for example, by display devices (e.g., a light-emitting diode (LED), an organic light-emitting diode (OLED), a liquid crystal display, a cathode ray tube display (CRT), a touchscreen, a tactile output device, a printer, and/or speakers). The interface circuit 720 of the illustrated example, thus, typically includes a graphics driver card, a graphics driver chip, or a graphics driver processor.

The interface circuit 720 of the illustrated example also includes a communication device, such as a transmitter, a receiver, a transceiver, a modem, and/or a network interface card to facilitate exchange of data with external machines (e.g., computing devices of any kind) via a network 726 (e.g., an Ethernet connection, a digital subscriber line (DSL), a telephone line, a coaxial cable, a cellular telephone system, etc.).

The processor platform 700 of the illustrated example also includes one or more mass storage devices 728 for storing software and/or data. Examples of such mass storage devices 728 include floppy disk drives, hard drive disks, compact disk drives, Blu-ray disk drives, RAID systems, and digital versatile disk (DVD) drives.

Coded instructions 732 of FIG. 7 may be stored in the mass storage device 728, in the volatile memory 714, in the non-volatile memory 716, and/or on a removable tangible computer readable storage medium such as a CD or DVD.

From the foregoing, it will be appreciated that the above disclosed systems, methods, and apparatus provide for efficient scheduling of on-demand refueling of a vehicle without requiring a user, such as a driver, to monitor the fuel level of the vehicle or find fuel providers to provider fuel. The disclosed examples automatically monitor a fuel level of the vehicle and generate requests for on-demand refueling of the vehicle. In generating the refuel requests, the disclosed examples consider user preferences received from a user's mobile device and/or environmental restrictions on refueling to identify available refueling providers, times, and locations. The disclosed examples send the refuel request to the user's mobile device for review and confirmation of the scheduled refuel request.

The disclosed examples also predictively schedule refueling events for the vehicle based on an analysis of historical vehicle usage data and/or scheduled trips input by the user. The disclosed examples identify patterns in the historical data to predict future usage of the vehicle, including predictions of destinations, routes, drive times, stop durations, and time of usage. Based on the predictions and/or user-input trip information, such as a planned route, the disclosed examples automatically determine the refueling needs of the vehicle and generate refueling requests for review by the user. Thus, the disclosed examples consider historical vehicle usage and anticipated vehicle usage. Further, the disclosed examples optimize the predictive scheduling of the refueling events based on considerations such as fuel costs and fuel provider availability at different times of the day. Therefore, the disclosed examples substantially eliminate the need for the user to monitor the vehicle fuel level and obtain fuel. Rather, the disclosed examples automatically generate refuel requests that anticipate the refueling needs of the vehicle, include conveniently scheduled refueling events in view of the user's driving habits, and benefit the user in leveraging fuel price drops.

Although certain example methods, apparatus, and articles of manufacture have been disclosed herein, the scope of coverage of this patent is not limited thereto. On the contrary, this patent covers all methods, apparatus, and articles of manufacture fairly falling within the scope of the claims of this patent.

What is claimed is:

1. A method comprising:
predicting, by executing an instruction with a processor, a vehicle usage event for a vehicle, the predicted vehicle usage event associated with a fuel amount;
comparing a fuel level of the vehicle and the fuel amount;
automatically generating, via the processor, a refuel request for the vehicle based on the comparison; and
transmitting the refuel request to a mobile device, the refuel request to be viewable via a user interface at the mobile device.

2. The method of claim 1, wherein predicting the vehicle usage event includes predicting one or more of a destination of the vehicle, a route of the vehicle, a stop duration of the vehicle, or a drive time of the vehicle.

3. The method of claim 1, wherein predicting the vehicle usage event is based on a plurality of vehicle usage events occurring before the predicted vehicle usage event.

4. The method of claim 3, further including identifying a pattern in the plurality of vehicle usage events.

5. The method of claim 1, further including accessing from the mobile device data indicative of a scheduled trip and determining at least one refuel event based on the scheduled trip data.

6. The method of claim 1, further including identifying a fuel provider based on one or more of an availability of the fuel provider, a fuel brand preference, a refuel location preference, or a refuel time preference.

7. The method of claim 1, wherein the vehicle usage event is a predicted route of the vehicle and further including:
identifying a first geographical location along the predicted route of the vehicle and a second geographical location along the predicted route;
performing a comparison of a first fuel price in the first geographical location to a second fuel price in the second geographical location; and
generating the refuel request based on the comparison of the first and second fuel prices.

8. The method of claim 1, further including adjusting the refuel event based on one or more of a fuel price or a calendar event.

9. The method of claim 1, further including accessing data indicative of a refueling of the vehicle and adjusting the refuel request based on the data.

10. An apparatus comprising:
an analyzer to identify a driving pattern associated with a vehicle;
a predictor to:
predict a driving event for the vehicle based on the driving pattern;
determine a fuel consumption of the vehicle for the predicted driving event; and
perform a comparison of the fuel consumption to a fuel level of the vehicle; and
a requester to:
generate a refuel request based on the comparison; and
transmit the refuel request to a mobile device, at least one of the analyzer, the predictor, or the requester to be implemented via a processor.

11. The apparatus of claim 10, further including a vehicle usage tracker to identify data indicative of usage of the vehicle.

12. The apparatus of claim 10, wherein the predictor is to predict a destination of the vehicle and a stop duration at the destination.

13. The apparatus of claim 12, further including an optimizer to adjust the refuel request based on the predicted stop duration.

14. The apparatus of claim 10, wherein the predictor is to determine a start time for the driving event and the requestor is to generate the request based on start time.

15. The apparatus of claim 10, wherein the predictor is to compare the fuel consumption to the fuel level based on a fuel level threshold.

16. The apparatus of claim 15, wherein the requestor is to identify at least one of a fuel provider to provide fuel at a location of the vehicle or a gas station.

17. A method comprising:
scheduling, by executing an instruction with a processor of a vehicle, a first refuel event for the vehicle;
transmitting, by executing an instruction with the processor, the scheduled refuel event to a mobile device, the scheduled refuel event to be viewable via a user interface at the mobile device;
accessing, at the processor, data indicative of a completion of the first refuel event; and
scheduling, by executing an instruction with the processor, a second refuel event based on the completion of the first refuel event.

18. The method of claim 17, further including:
determining a fuel price;
performing a comparison of the fuel price to a fuel price trigger; and
transmitting a request to the mobile device for scheduling of the first refuel event based on the comparison.

19. The method of claim 18, further including:
detecting a calendar event; and
scheduling the first refuel event based on the calendar event, the calendar event to be transmitted from the mobile device to the processor.

20. The method of claim 19, further including adjusting the first refuel event based on a day of the week of the calendar event.
